(19) United States
(12) Patent Application Publication
(10) Pub. No.: US 2021/0287025 A1
(43) Pub. Date: Sep. 16, 2021

(54) FINGER VEIN IMAGING DEVICES AND FINGER VEIN AUTHENTICATION SYSTEMS HAVING THE SAME

(71) Applicants: NANJING EASTHOUSE INFORMATION TECHNOLOGY CO., LTD., NANJING (CN); NANJING EASTHOUSE ELECTRICAL CO., LTD., NANJING (CN)

(72) Inventor: HAO MIN, NANJING (CN)

(73) Assignees: NANJING EASTHOUSE INFORMATION TECHNOLOGY CO., LTD., NANJING, OT (CN); NANJING EASTHOUSE ELECTRICAL CO., LTD., NANJING, OT (CN)

(21) Appl. No.: 16/326,368

(22) PCT Filed: Nov. 14, 2017
(86) PCT No.: PCT/CN2017/110943

§ 371 Date: Feb. 18, 2019

Related U.S. Application Data
(63) Continuation of application No. PCT/CN2017/110943, filed on Nov. 14, 2017.

(51) Int. Cl. G06K 9/00; G06K 9/20; G07C 9/00

(52) U.S. Cl. CPC G06K 9/00885; G06K 9/209; G06K 2009/00932; G07C 9/00563; G07C 9/00912

(57) ABSTRACT

The present disclosure relates to finger vein imaging devices and finger vein authentication systems. In certain embodiments, the finger vein authentication system includes at least one finger vein imaging device and a finger vein authentication controller. The finger vein imaging device includes one or more finger vein image sensors for capturing infrared image of finger vein pattern of a user's finger, an in-position touch sensor, and one or more infrared light sources positioned at opposite side of the finger vein image sensors. When the user's finger is placed on a transparent finger resting surface and touches the in-position touch sensor, the finger vein imaging device is triggered to turn on the infrared light sources and to capture infrared image of finger vein patterns of the user's finger, and the finger vein authentication controller authenticate the user using the captured infrared images of finger vein patterns of the user's finger.

### FIELD

The present disclosure generally relates to user authentication, and more particularly to several finger vein imaging devices, finger vein authentication systems having the finger vein imaging devices, and methods of using the finger vein authentication systems.

### BACKGROUND

Finger vein sensors have been widely used for user authentication. However, the conventional finger vein sensors have some issues that need to be improved. Currently, only a small portion of the finger vein pattern is captured for user authentication. It is desirable to use larger images of finger vein pattern to improve authentication accuracy. Additionally, since three-dimensional finger vein patterns provide more detail of the distinctive finger vein patterns, a finger vein authentication system using three-dimensional finger vein patterns will further improve the accuracy of the user authentication.

Therefore, heretofore unaddressed needs still exist in the art to address the aforementioned deficiencies and inadequacies.

### SUMMARY

In one aspect, the present disclosure relates to a finger vein imaging device. In certain embodiments, the finger vein imaging device includes: one or more finger vein image sensors for capturing at least one infrared image of finger vein pattern of a target human's finger; and one or more infrared light sources positioned at an opposite side of the one or more finger vein image sensors. The finger is positioned between the one or more infrared light sources and the one or more finger vein image sensors. The infrared light from the one or more infrared light sources irradiates the finger to generate the infrared image of finger vein pattern of the finger on the one or more finger vein image sensors, and the one or more finger vein image sensors captures the infrared image of finger vein pattern of the finger.

In certain embodiments, each of the one or more infrared light sources includes an infrared light-emitting diode (LED), a near-infrared LED, an infrared light bulb, a near-infrared light bulb and any other infrared and near-infrared light sources. The one or more infrared light sources may be arranged in one or more rows and one or more columns on an infrared light source panel.

In certain embodiments, each of the one or more finger vein image sensors includes: a finger vein image sensor, a lens positioned between the finger and the finger vein image sensor, and an infrared filter positioned between the lens and the finger vein image sensor for improving quality of the infrared image of finger vein pattern of the finger.

In certain embodiments, the finger vein imaging device includes a rectangular-shaped finger vein sensor enclosure. The finger vein sensor enclosure includes a lower compartment for positioning the one or more infrared light sources and an upper compartment for positioning the one or more finger vein image sensors. Top surface of the lower compartment includes a transparent finger resting surface to rest the finger, and an in-position touch sensor. When the finger is placed on the transparent finger resting surface and touches the in-position touch sensor, the finger vein imaging device is triggered to turn on the one or more infrared light sources and to capture at least one infrared image of finger vein pattern of the finger.

In certain embodiments, the finger vein imaging device includes a cylindrical finger vein sensor enclosure having a hollow inside, open in a first end, and closed in a second end for positioning the one or more infrared light sources and the one or more finger vein image sensors, the closed second end further includes a transparent finger resting surface to rest the finger, and an in-position touch sensor. When the finger is placed on the transparent finger resting surface and touches the in-position touch sensor, the finger vein imaging device is triggered to turn on the one or more infrared light sources and to capture at least one infrared image of finger vein pattern of the finger. In certain embodiments, the cylindrical finger vein sensor enclosure may also include one or more optical reflectors. The one or more optical reflectors include a reflecting mirror, a triangular reflecting glass, and any other optical reflecting devices.

In another aspect, the present disclosure relates to a finger vein authentication system. In certain embodiments, the finger vein authentication system includes at least one finger vein imaging device, and a finger vein authentication controller. The finger vein imaging device includes one or more finger vein image sensors for capturing at least one infrared image of finger vein pattern of a target human's finger resting on a transparent finger resting surface, an in-position touch sensor, and one or more infrared light sources positioned at an opposite side of the one or more finger vein image sensors. When the finger is placed on the transparent finger resting surface and touches the in-position touch sensor, the finger vein imaging device is triggered to turn on the one or more infrared light sources and to capture one or more infrared image of finger vein patterns of the finger.

In certain embodiments, the finger vein authentication controller includes a processor and a non-volatile memory. The non-volatile memory stores an operating system and a finger vein authentication application. In certain embodiments, the finger vein authentication application includes: a finger vein image storage module, a finger vein image processing module, and a finger vein authentication module. When executed by the processor, the finger vein authentication application causes the processor to perform one or more of: receiving, by the finger vein image storage module, captured one or more infrared image of finger vein patterns of the finger, when the finger vein imaging device captures the one or more infrared image of finger vein patterns of the finger, and comparing, by the finger vein image processing module, the captured one or more infrared image of finger vein patterns of the finger with a set of infrared images of finger vein patterns stored in the finger vein image storage module. When the captured one or more infrared image of finger vein patterns of the finger match at least one of the set of infrared images of finger vein patterns stored in the finger vein image storage module, the finger vein authentication module generates a positive authentication. When the captured one or more infrared image of finger vein patterns of the finger do not match at least one of the set of infrared images of finger vein patterns stored in the finger vein image storage module, the finger vein authentication module generates a negative authentication.

In certain embodiments, the finger vein authentication system further includes a finger vein image database for providing the set of infrared images of finger vein patterns to be stored in the finger vein image storage module of the finger vein authentication application.

In certain embodiments, the finger vein authentication system includes a group of finger vein authentication application systems. These finger vein authentication application systems include: a banking user authentication system, a credit card authentication system, an automotive driver authentication system, a firearm user authentication system, an employee security authentication system, a computer and network authentications system, an end point security system, an intelligent lock, an intelligent lock for safe and gun lockers, and an automated teller machine authentication system.

In certain embodiments, each of the one or more infrared light sources includes an infrared light-emitting diode (LED), a near-infrared LED, an infrared light bulb, a near-infrared light bulb and any other infrared and near-infrared light sources. In certain embodiments, the one or more infrared light sources are arranged in one or more rows and one or more columns on an infrared light source panel.

In certain embodiments, each of the one or more finger vein image sensors includes: a finger vein image sensor, a lens positioned between the finger and the finger vein image sensor, and an infrared filter positioned between the lens and the finger vein image sensor for improving quality of the infrared image of finger vein pattern of the finger.

In one embodiment, the finger vein authentication system includes a rectangular-shaped finger vein sensor enclosure. The finger vein sensor enclosure has a lower compartment, and an upper compartment. The one or more infrared light sources are positioned inside of the lower compartment, and the one or more finger vein image sensors are positioned inside of the upper compartment. A top surface of the lower compartment includes a transparent finger resting surface and the finger is to be placed on the transparent finger resting surface when the infrared image of finger vein pattern of the finger is taken. The finger vein sensor enclosure also includes an in-position touch sensor. When the finger is placed on the transparent finger resting surface and touches the in-position touch sensor, the finger vein imaging device is triggered to turn on the one or more infrared light sources and to capture at least one infrared image of finger vein pattern of the finger.

In another embodiment, the finger vein authentication system includes a cylindrical finger vein sensor enclosure. The finger vein sensor enclosure is hollow inside, and it is open in a first end, and closed in a second end. The one or more infrared light sources and the one or more finger vein image sensors are positioned on the inside wall of the finger vein sensor enclosure. The closed second end further includes a transparent finger resting surface to rest the finger, and an in-position touch sensor. When the finger is placed on the transparent finger resting surface and touches the in-position touch sensor, the finger vein imaging device is triggered to turn on the one or more infrared light sources and to capture at least one infrared image of finger vein pattern of the finger.

In certain embodiments, the cylindrical finger vein sensor enclosure may include one or more optical reflectors. The one or more optical reflectors includes a reflecting mirror, a triangular reflecting glass, and any other optical reflecting devices.

In yet another aspect, the present disclosure relates to a method of using a finger vein authentication system. In certain embodiments, the method includes: retrieving, by a finger vein image storage module of a finger vein authentication application, a set of infrared images of finger vein patterns from a finger vein image database, and storing the retrieved infrared images of finger vein patterns in the finger vein image storage module, connecting one or more finger vein imaging devices 10 to a finger vein authentication controller to capture one or more infrared images of finger vein pattern of a target human's finger, and receiving captured one or more infrared image of finger vein patterns of the finger, by the finger vein image storage module of the finger vein authentication application, when the finger vein imaging device captures the one or more infrared image of finger vein patterns of the finger.

In certain embodiments, the method includes: comparing, by a finger vein image processing module of the finger vein authentication application, the captured one or more infrared image of finger vein patterns of the finger with the set of infrared images of finger vein patterns stored in the finger vein image storage module. When the captured one or more infrared image of finger vein patterns of the finger match at least one of the set of infrared images of finger vein patterns stored in the finger vein image storage module, the finger vein authentication module generates a positive authentication. When the captured one or more infrared image of finger vein patterns of the finger do not match at least one of the set of infrared images of finger vein patterns stored in the finger vein image storage module, the finger vein authentication module generates a negative authentication.

In certain embodiments, the finger vein authentication system includes at least one finger vein imaging device, and the finger vein authentication controller. The finger vein imaging device includes one or more finger vein image sensors for capturing at least one infrared image of finger vein pattern of a target human's finger resting on a transparent finger resting surface, an in-position touch sensor, and one or more infrared light sources positioned at an opposite side of the one or more finger vein image sensors. When the finger is placed on the transparent finger resting surface and touches the in-position touch sensor, the finger vein imaging device is triggered to turn on the one or more infrared light sources and to capture one or more infrared image of finger vein patterns of the finger. In certain embodiments, the finger vein authentication controller includes a processor and a non-volatile memory. The non-volatile memory stores an operating system and the finger vein authentication application. The finger vein authentication application includes: the finger vein image storage module, the finger vein image processing module, and the finger vein authentication module.

In certain embodiments, each of the one or more infrared light sources include an infrared light-emitting diode (LED), a near-infrared LED, an infrared light bulb, a near-infrared light bulb and any other infrared and near-infrared light sources. The one or more infrared light sources may be arranged in one or more rows and one or more columns on an infrared light source panel.

In certain embodiments, each of the one or more finger vein image sensors includes: a finger vein image sensor, a lens positioned between the finger and the finger vein image sensor, and an infrared filter positioned between the lens and the finger vein image sensor for improving quality of the infrared image of finger vein pattern of the finger.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the present disclosure, and features and benefits thereof, and together with the written description, serve to explain the principles of the present invention. Wherever possible, the same reference numbers are used throughout the drawings to refer to the same or like elements of an embodiment, and wherein:

FIG. 1 shows a block diagram of a finger vein imaging device according to certain embodiments of the present disclosure;

FIG. 2 shows a cross-sectional view of a two-dimensional finger vein imaging device according to certain embodiments of the present disclosure;

FIG. 3 shows a cross-sectional view of a three-dimensional finger vein imaging device according to one embodiment of the present disclosure;

FIG. 4 shows a cross-sectional view of another three-dimensional finger vein imaging device according to another embodiment of the present disclosure;

FIG. 5 shows a block diagram of a finger vein authentication system according to certain embodiments of the present disclosure; and

FIG. 6 shows a flowchart of a method of using the finger vein authentication system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or conconventionally) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art Like numbers refer to like elements throughout.

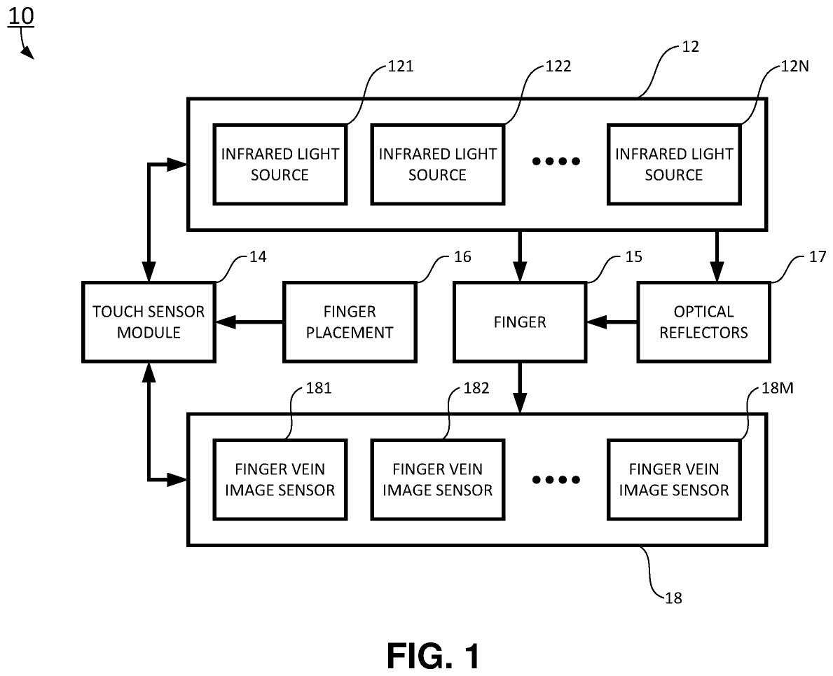

Referring now to FIGS. 1-4, in one aspect, the present disclosure relates to various types of finger vein imaging devices 10. In certain embodiments, the finger vein imaging device 10 includes: one or more finger vein image sensors 18 for capturing at least one infrared image of finger vein pattern of a target human's finger 15; and one or more infrared light sources 12 positioned at an opposite side of the one or more finger vein image sensors 18. As shown in FIG. 1, the one or more finger vein image sensors 18 include a first finger vein image sensor 181, a second finger vein image sensor 182, . . . , and a M-th finger vein image sensor 18M, where M is a positive integer, and the one or more infrared light sources 12 include a first infrared light source 121, a first infrared light source 122, . . . , and an M-th infrared light source 12N, where N is a positive integer.

In certain embodiments, the target human's finger 15 or the finger 15 is placed on a finger placement 16. The finger placement 16 is positioned between the one or more infrared light sources 12 and the one or more finger vein image sensors 18. The finger placement 16 includes at least a transparent surface 162 where the finger 15 may be placed. In certain embodiments, in order to obtain consistent finger vein patterns of the finger 15, an in-position touch sensor 142 is placed in the finger placement 16. When the finger 15 is placed in the right place and the tip of the finger 15 touches the in-position touch sensor 142, the in-position touch sensor 142 triggers a touch sensor module 14 to capture one or more finger vein images of the finger 15. The infrared light from the one or more infrared light sources 12 irradiates the finger 15 to generate the infrared image of finger vein pattern of the finger 15 on the one or more finger vein image sensors 18, and the one or more finger vein image sensors 18 captures the infrared image of finger vein pattern of the finger 15.

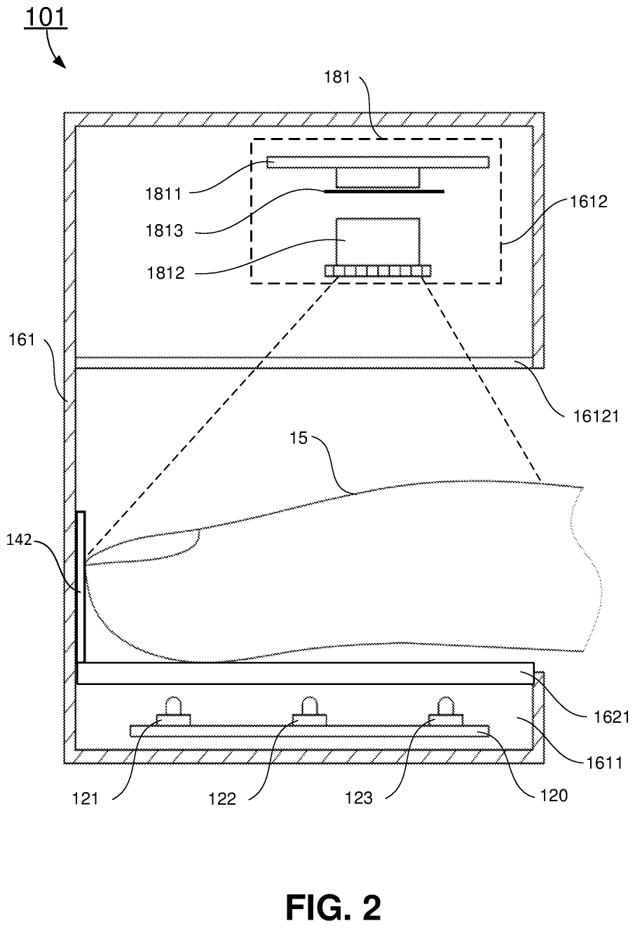

In certain embodiments, each of the one or more infrared light sources 12 include an infrared light-emitting diode (LED), a near-infrared LED, an infrared light bulb, a near-infrared light bulb and any other infrared and near-infrared light sources. The one or more infrared light sources 12 may be arranged in one or more rows and one or more columns on an infrared light source panel 120 as shown in FIG. 2.

In certain embodiments, as shown in FIG. 2, each of the one or more finger vein image sensors 18 includes: a finger vein image sensor 1811, a lens 1812 positioned between the finger 15 and the finger vein image sensor 1811, and an infrared filter 1813 positioned between the lens 1812 and the finger vein image sensor 1811 for improving quality of the infrared image of finger vein pattern of the finger 15.

In certain embodiments, a two-dimensional finger vein imaging device 101 is shown in FIG. 2. The finger vein imaging device 101 includes a rectangular-shaped finger vein sensor enclosure 161. The finger vein sensor enclosure 161 includes a lower compartment 1611 for positioning the a first infrared light source 121, a second infrared light source 122, and a third infrared light source 123 and an upper compartment 1612 for positioning a finger vein image sensor 181. Top surface of the lower compartment 1611 forms a transparent finger resting surface 1621 to place the finger 15, and an in-position touch sensor 142. When the finger 15 is placed in the right place and the tip of the finger 15 touches the in-position touch sensor 142, the in-position touch sensor 142 triggers the touch sensor module 14 to capture one or more two-dimensional finger vein images of the finger 15. The infrared light from the infrared light sources 121, 122, and 123 irradiate the finger 15 to generate a two-dimensional infrared image of finger vein pattern of the finger 15 on the finger vein image sensor 181. The finger vein image sensor 181 captures the infrared image of finger vein pattern of the finger 15.

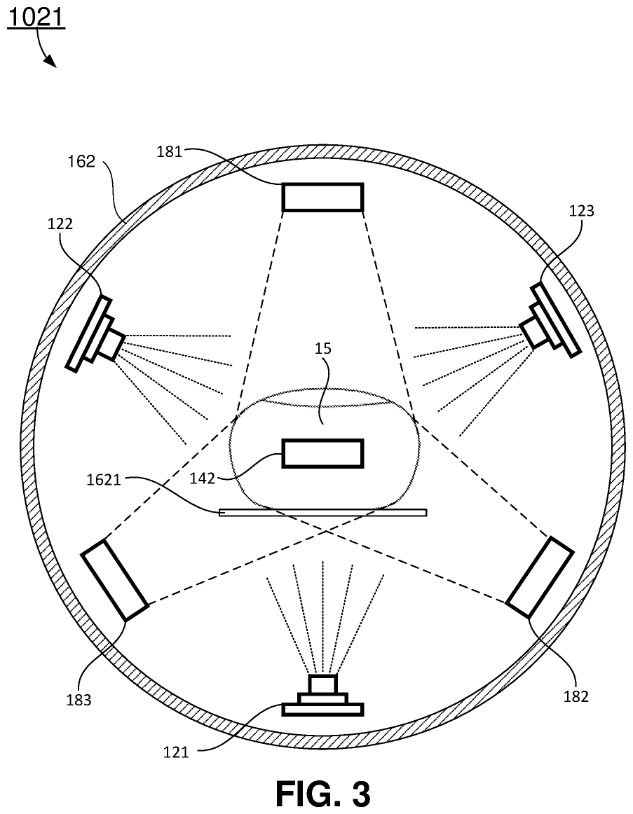

Referring now to FIG. 3, a three-dimensional finger vein imaging device 1021 is shown according to certain embodiments of the present disclosure. The finger vein imaging device 1021 includes a cylindrical finger vein sensor enclosure 162. The cylindrical finger vein sensor enclosure 162 has a hollow inside, open in a first end, and closed in a second end. The cylindrical finger vein sensor enclosure 162 is used to position the one or more infrared light sources 12 and the one or more finger vein image sensors 18. In one embodiment, as shown in FIG. 3, the three-dimensional finger vein imaging device 1021 includes a first infrared light source 121, a second infrared light source 122, and a third infrared light source 123, equally spaced around the inside wall of the cylindrical finger vein sensor enclosure 162. The three-dimensional finger vein imaging device 1021 also includes a first finger vein image sensor 181, a second finger vein image sensor 182, and a third finger vein image sensor 183. Each of the three finger vein image sensors 181, 182, and 183 are equally spaced around the inside wall of the cylindrical finger vein sensor enclosure 162 and placed on an opposite side to each of three corresponding infrared light sources 121, 122, and 123, with the finger 15 placed in the center.

In certain embodiments, the closed second end further includes a transparent finger resting surface 1621 to rest the finger 15, and an in-position touch sensor 142. When the finger 15 is placed in the right place and the tip of the finger 15 touches the in-position touch sensor 142, the in-position touch sensor 142 triggers the touch sensor module 14 to capture one or more two-dimensional finger vein images of the finger 15. The infrared light from the infrared light sources 121, 122, and 123 irradiate the finger 15 to generate three two-dimensional infrared image of finger vein pattern of the finger 15 on each of the finger vein image sensors 181, 182, and 183. These two-dimensional infrared images of finger vein pattern of the finger 15 are captured by the finger vein image sensors 181, 182, and 183, respectively. A finger vein image processing module of a finger vein authentication system may be used to generate a three-dimensional infrared images of finger vein pattern of the finger 15. This three-dimensional infrared image of finger vein pattern of the finger 15 may be used to authenticate user with higher authentication accuracy.

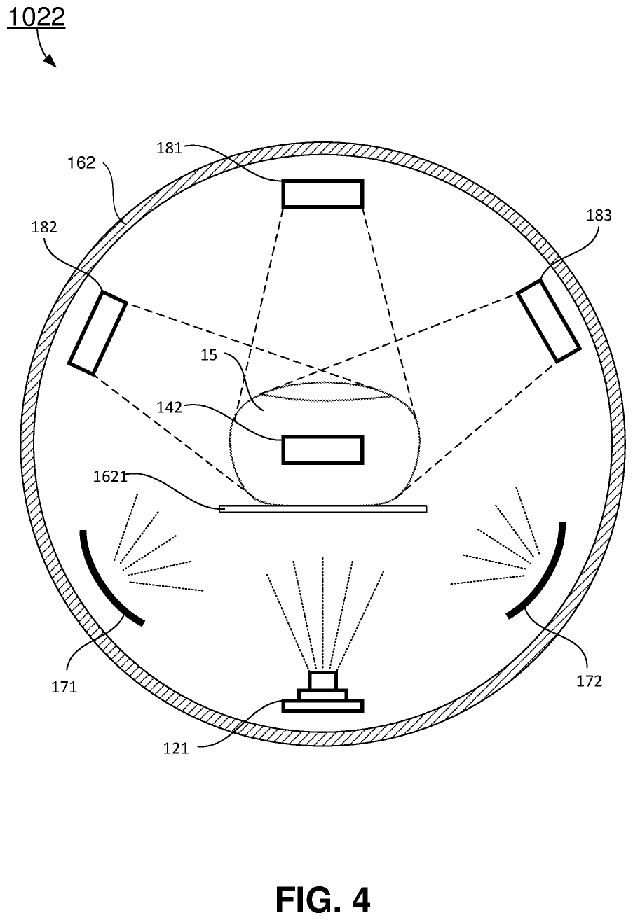

Referring now to FIG. 4, another three-dimensional finger vein imaging device 1022 is shown according to certain embodiments of the present disclosure. The finger vein imaging device 1021 includes a cylindrical finger vein sensor enclosure 162. The cylindrical finger vein sensor enclosure 162 has a hollow inside, open in a first end, and closed in a second end. The three-dimensional finger vein imaging device 1022 also includes a first finger vein image sensor 181, a second finger vein image sensor 182, and a third finger vein image sensor 183. An infrared light source 121 is placed at the bottom of the cylindrical finger vein sensor enclosure 162. A first optical reflector 171 is placed on one side of the infrared light source 121, and a second optical reflector 172 is placed on another side of the infrared light source 121. The first optical reflector 171 and the second optical reflector 172 are used to reflect the infrared light generate by the infrared light source 121 to form a two-dimensional infrared images of finger vein pattern of the finger 15 one each of the first finger vein image sensor 181, the second finger vein image sensor 182, and the third finger vein image sensor 183, respectively.

In certain embodiments, the closed second end further includes a transparent finger resting surface 1621 to rest the finger 15, and an in-position touch sensor 142. When the finger 15 is placed in the right place and the tip of the finger 15 touches the in-position touch sensor 142, the in-position touch sensor 142 triggers the touch sensor module 14 to capture the three two-dimensional finger vein images of the finger 15. The infrared light from the infrared light source 121 and reflected by the first optical reflector 171 and the second optical reflector 172 irradiate the finger 15 to generate three two-dimensional infrared image of finger vein pattern of the finger 15 on each of the finger vein image sensors 181, 182, and 183. These two-dimensional infrared images of finger vein pattern of the finger 15 are captured by the finger vein image sensors 181, 182, and 183, respectively. A finger vein image processing module of a finger vein authentication system may be used to generate a three-dimensional infrared images of finger vein pattern of the finger 15. This three-dimensional infrared image of finger vein pattern of the finger 15 may be used to authenticate user with higher authentication accuracy.

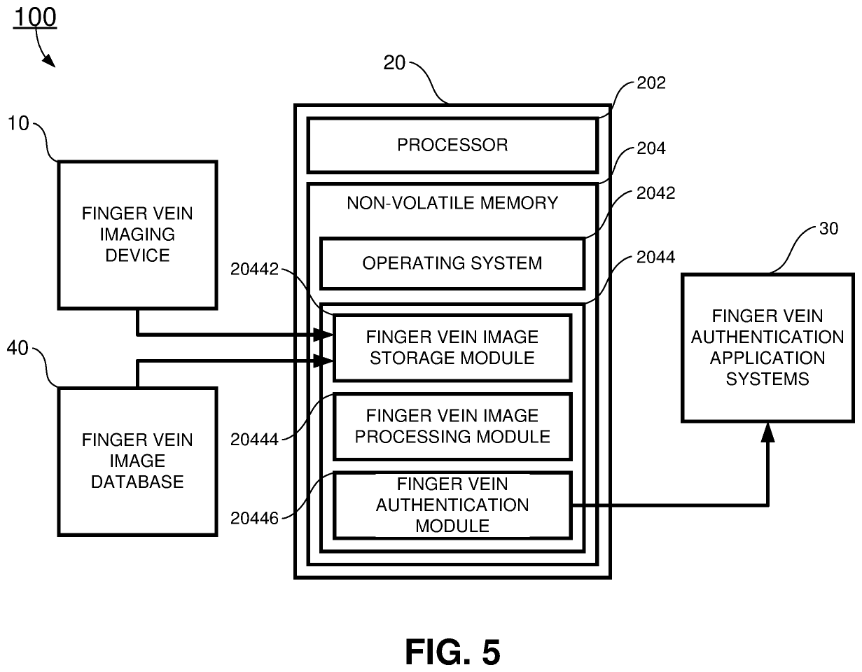

In another aspect, as shown in FIG. 5, the present disclosure relates to a finger vein authentication system 100. In certain embodiments, the finger vein authentication system 100 includes at least one finger vein imaging device 10, and a finger vein authentication controller 20.

In certain embodiments, the finger vein imaging device 10 includes: one or more finger vein image sensors 18 for capturing at least one infrared image of finger vein pattern of a target human's finger 15; and one or more infrared light sources 12 positioned at an opposite side of the one or more finger vein image sensors 18. As shown in FIG. 1, the one or more finger vein image sensors 18 include a first finger vein image sensor 181, a second finger vein image sensor 182, . . . , and a M-th finger vein image sensor 18M, where M is a positive integer, and the one or more infrared light sources 12 include a first infrared light source 121, a first infrared light source 122, . . . , and an M-th infrared light source 12N, where N is a positive integer.

In certain embodiments, the target human's finger 15 or the finger 15 is placed on a finger placement 16. The finger placement 16 is positioned between the one or more infrared light sources 12 and the one or more finger vein image sensors 18. The finger placement 16 includes at least a transparent surface 162 where the finger 15 may be placed. In certain embodiments, in order to obtain consistent finger vein patterns of the finger 15, an in-position touch sensor 142 is placed in the finger placement 16. When the finger 15 is placed in the right place and the tip of the finger 15 touches the in-position touch sensor 142, the in-position touch sensor 142 triggers a touch sensor module 14 to capture one or more finger vein images of the finger 15. The infrared light from the one or more infrared light sources 12 irradiates the finger 15 to generate the infrared image of finger vein pattern of the finger 15 on the one or more finger vein image sensors 18, and the one or more finger vein image sensors 18 captures the infrared image of finger vein pattern of the finger 15.

In certain embodiments, each of the one or more infrared light sources 12 include an infrared light-emitting diode (LED), a near-infrared LED, an infrared light bulb, a near-infrared light bulb and any other infrared and near-infrared light sources. The one or more infrared light sources 12 may be arranged in one or more rows and one or more columns on an infrared light source panel 120 as shown in FIG. 2.

In certain embodiments, as shown in FIG. 2, each of the one or more finger vein image sensors 18 includes: a finger vein image sensor 1811, a lens 1812 positioned between the finger 15 and the finger vein image sensor 1811, and an infrared filter 1813 positioned between the lens 1812 and the finger vein image sensor 1811 for improving quality of the infrared image of finger vein pattern of the finger 15.

In certain embodiments, a two-dimensional finger vein imaging device 101 is shown in FIG. 2. The finger vein imaging device 101 includes a rectangular-shaped finger vein sensor enclosure 161. The finger vein sensor enclosure 161 includes a lower compartment 1611 for positioning the a first infrared light source 121, a second infrared light source 122, and a third infrared light source 123 and an upper compartment 1612 for positioning a finger vein image sensor 181. Top surface of the lower compartment 1611 forms a transparent finger resting surface 1621 to place the finger 15, and an in-position touch sensor 142. When the finger 15 is placed in the right place and the tip of the finger 15 touches the in-position touch sensor 142, the in-position touch sensor 142 triggers the touch sensor module 14 to capture one or more two-dimensional finger vein images of the finger 15. The infrared light from the infrared light sources 121, 122, and 123 irradiate the finger 15 to generate a two-dimensional infrared image of finger vein pattern of the finger 15 on the finger vein image sensor 181. The finger vein image sensor 181 captures the infrared image of finger vein pattern of the finger 15.

Referring now to FIG. 3, a three-dimensional finger vein imaging device 1021 is shown according to certain embodiments of the present disclosure. The finger vein imaging device 1021 includes a cylindrical finger vein sensor enclosure 162. The cylindrical finger vein sensor enclosure 162 has a hollow inside, open in a first end, and closed in a second end. The cylindrical finger vein sensor enclosure 162 is used to position the one or more infrared light sources 12 and the one or more finger vein image sensors 18. In one embodiment, as shown in FIG. 3, the three-dimensional finger vein imaging device 1021 includes a first infrared light source 121, a second infrared light source 122, and a third infrared light source 123, equally spaced around the inside wall of the cylindrical finger vein sensor enclosure 162. The three-dimensional finger vein imaging device 1021 also includes a first finger vein image sensor 181, a second finger vein image sensor 182, and a third finger vein image sensor 183. Each of the three finger vein image sensors 181, 182, and 183 are equally spaced around the inside wall of the cylindrical finger vein sensor enclosure 162 and placed on an opposite side to each of three corresponding infrared light sources 121, 122, and 123, with the finger 15 placed in the center.

In certain embodiments, the closed second end further includes a transparent finger resting surface 1621 to rest the finger 15, and an in-position touch sensor 142. When the finger 15 is placed in the right place and the tip of the finger 15 touches the in-position touch sensor 142, the in-position touch sensor 142 triggers the touch sensor module 14 to capture one or more two-dimensional finger vein images of the finger 15. The infrared light from the infrared light sources 121, 122, and 123 irradiate the finger 15 to generate three two-dimensional infrared image of finger vein pattern of the finger 15 on each of the finger vein image sensors 181, 182, and 183. These two-dimensional infrared images of finger vein pattern of the finger 15 are captured by the finger vein image sensors 181, 182, and 183, respectively. A finger vein image processing module of a finger vein authentication system may be used to generate a three-dimensional infrared images of finger vein pattern of the finger 15. This three-dimensional infrared image of finger vein pattern of the finger 15 may be used to authenticate user with higher authentication accuracy.

Referring now to FIG. 4, another three-dimensional finger vein imaging device 1022 is shown according to certain embodiments of the present disclosure. The finger vein imaging device 1021 includes a cylindrical finger vein sensor enclosure 162. The cylindrical finger vein sensor enclosure 162 has a hollow inside, open in a first end, and closed in a second end. The three-dimensional finger vein imaging device 1022 also includes a first finger vein image sensor 181, a second finger vein image sensor 182, and a third finger vein image sensor 183. An infrared light source 121 is placed at the bottom of the cylindrical finger vein sensor enclosure 162. A first optical reflector 171 is placed on one side of the infrared light source 121, and a second optical reflector 172 is placed on another side of the infrared light source 121. The first optical reflector 171 and the second optical reflector 172 are used to reflect the infrared light generate by the infrared light source 121 to form a two-dimensional infrared images of finger vein pattern of the finger 15 one each of the first finger vein image sensor 181, the second finger vein image sensor 182, and the third finger vein image sensor 183, respectively.

In certain embodiments, the closed second end further includes a transparent finger resting surface 1621 to rest the finger 15, and an in-position touch sensor 142. When the finger 15 is placed in the right place and the tip of the finger 15 touches the in-position touch sensor 142, the in-position touch sensor 142 triggers the touch sensor module 14 to capture the three two-dimensional finger vein images of the finger 15. The infrared light from the infrared light source 121 and reflected by the first optical reflector 171 and the second optical reflector 172 irradiate the finger 15 to generate three two-dimensional infrared image of finger vein pattern of the finger 15 on each of the finger vein image sensors 181, 182, and 183. These two-dimensional infrared images of finger vein pattern of the finger 15 are captured by the finger vein image sensors 181, 182, and 183, respectively. A finger vein image processing module of a finger vein authentication system may be used to generate a three-dimensional infrared images of finger vein pattern of the finger 15. This three-dimensional infrared image of finger vein pattern of the finger 15 may be used to authenticate user with higher authentication accuracy.

In certain embodiments, as shown in FIG. 5, the finger vein authentication controller 20 includes a processor 202 and a non-volatile memory 204. The non-volatile memory 204 stores an operating system 2042 and a finger vein authentication application 2044. In certain embodiments, the finger vein authentication application 2044 includes: a finger vein image storage module 20442, a finger vein image processing module 20444, and a finger vein authentication module 20446. When executed by the processor 202, the finger vein authentication application 2044 causes the processor 202 to perform one or more of: receiving, by the finger vein image storage module 20442, captured one or more infrared image of finger vein patterns of the finger 15, when the finger vein imaging device 10 captures the one or more infrared image of finger vein patterns of the finger 15, and comparing, by the finger vein image processing module 20444, the captured one or more infrared image of finger vein patterns of the finger 15 with a set of infrared images of finger vein patterns stored in the finger vein image storage module 20442. When the captured infrared image of finger vein patterns of the finger 15 match at least one of the set of infrared images of finger vein patterns stored in the finger vein image storage module 20442, the finger vein authentication module 20446 generates a positive authentication. When the captured infrared image of finger vein patterns of the finger 15 do not match at least one of the set of infrared images of finger vein patterns stored in the finger vein image storage module 20442, the finger vein authentication module 20446 generates a negative authentication.

In certain embodiments, the finger vein authentication system 100 further includes a finger vein image database 40 for providing the set of infrared images of finger vein patterns to be stored in the finger vein image storage module 20442 of the finger vein authentication application 2044.

In certain embodiments, the finger vein authentication system 100 includes a group of finger vein authentication application systems 30. These finger vein authentication application systems 30 include: a banking user authentication system, a credit card authentication system, an automotive driver authentication system, a firearm user authentication system, an employee security authentication system, a computer and network authentications system, an end point security system, an intelligent lock, an intelligent lock for safe and gun lockers, and an automated teller machine authentication system.

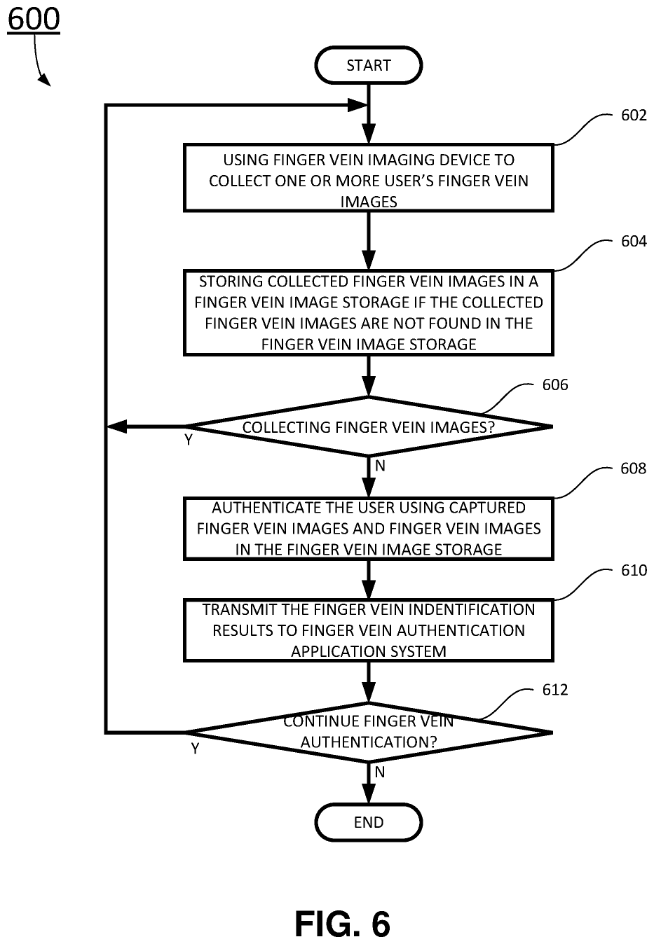

In yet another aspect, as shown in FIG. 6, the present disclosure relates to a method 600 of using a finger vein authentication system 100. In certain embodiments, as shown in FIG. 5, the finger vein authentication system 100 includes at least one finger vein imaging device 10, and a finger vein authentication controller 20, a group of finger vein authentication application systems 30, and a finger vein image database 40.

for providing the set of infrared images of finger vein patterns to be stored in the finger vein image storage module 20442 of the finger vein authentication application 2044.

In certain embodiments, the finger vein imaging device 10 may include a two-dimensional finger vein imaging device 101 as shown in FIG. 2, and three-dimensional finger vein imaging devices 1021 and 1022 as shown in FIG. 3 and FIG. 4. The finger vein imaging device 10 is used to capture one or more infrared images of finger vein patterns of a target human finger 15.

The finger vein authentication controller 20 includes a processor 202 and a non-volatile memory 204. The non-volatile memory 204 stores an operating system 2042 and a finger vein authentication application 2044. In certain embodiments, the finger vein authentication application 2044 includes: a finger vein image storage module 20442, a finger vein image processing module 20444, and a finger vein authentication module 20446. When executed by the processor 202, the finger vein authentication application 2044 causes the processor 202 to perform one or more of: receiving, by the finger vein image storage module 20442, captured one or more infrared image of finger vein patterns of the finger 15, when the finger vein imaging device 10 captures the one or more infrared image of finger vein patterns of the finger 15, and comparing, by the finger vein image processing module 20444, the captured one or more infrared image of finger vein patterns of the finger 15 with a set of infrared images of finger vein patterns stored in the finger vein image storage module 20442. When the captured infrared image of finger vein patterns of the finger 15 match at least one of the set of infrared images of finger vein patterns stored in the finger vein image storage module 20442, the finger vein authentication module 20446 generates a positive authentication. When the captured infrared image of finger vein patterns of the finger 15 do not match at least one of the set of infrared images of finger vein patterns stored in the finger vein image storage module 20442, the finger vein authentication module 20446 generates a negative authentication.

The group of finger vein authentication application systems 30 include: a banking user authentication system, a credit card authentication system, an automotive driver authentication system, a firearm user authentication system, an employee security authentication system, a computer and network authentications system, an end point security system, an intelligent lock, an intelligent lock for safe and gun lockers, and an automated teller machine authentication system.

In certain embodiments, the finger vein image database 40 provides the set of infrared images of finger vein patterns to be stored in the finger vein image storage module 20442 of the finger vein authentication application 2044. The set of infrared images of finger vein patterns is used to authenticate users.

In certain embodiments, the method 600 includes: retrieving, by the finger vein image storage module 20442 of the finger vein authentication application 2044, the set of infrared images of finger vein patterns from the finger vein image database 40, and storing the retrieved infrared images of finger vein patterns in the finger vein image storage module 20442, connecting one or more finger vein imaging devices 10 to a finger vein authentication controller 20 to capture one or more infrared images of finger vein pattern of a target human's finger 15, and receiving captured one or more infrared image of finger vein patterns of the finger 15, by the finger vein image storage module 20442 of the finger vein authentication application 2044, when the finger vein imaging device 10 captures the one or more infrared image of finger vein patterns of the finger 15.

In one embodiment, the captured infrared image of finger vein patterns of the finger 15 include two-dimensional infrared image of finger vein patterns of the finger 15 captured by the two-dimensional finger vein imaging device 101 as shown in FIG. 2. In other embodiments, the captured infrared image of finger vein patterns of the finger 15 include three-dimensional infrared image of finger vein patterns of the finger 15 captured by the three-dimensional finger vein imaging devices 1021 as shown in FIG. 3, and 1022 as shown in FIG. 4.

In certain embodiments, the method 600 also includes: comparing, by the finger vein image processing module 20444 of the finger vein authentication application 2044, the captured infrared image of finger vein patterns of the finger 15 with the set of infrared images of finger vein patterns stored in the finger vein image storage module 20442. When the captured infrared image of finger vein patterns of the finger 15 match at least one of the set of infrared images of finger vein patterns stored in the finger vein image storage module 20442, the finger vein authentication module 20446 generates a positive authentication. When the captured infrared image of finger vein patterns of the finger 15 do not match at least one of the set of infrared images of finger vein patterns stored in the finger vein image storage module 20442, the finger vein authentication module 20446 generates a negative authentication.

Referring now to FIG. 6, a flowchart of the method 600 of using the finger vein authentication system 100 is shown according to certain embodiments of the present disclosure.

At block 602, a user uses a finger vein imaging device 10 to collect one or more infrared image of finger vein patterns of the finger 15. The user places one of the fingers on a transparent finger resting surface 1621. When the finger 15 is placed in the right place and the tip of the finger 15 touches the in-position touch sensor 142, the in-position touch sensor 142 triggers the touch sensor module 14 to capture one or more two-dimensional finger vein images of the finger 15. The infrared light sources 12 irradiate the finger 15 to generate one or more infrared images of finger vein pattern of the finger 15 on the one or more finger vein image sensors 18. The one or more finger vein image sensors 18 capture the infrared images of finger vein pattern of the finger 15.

At block 604, the finger vein image processing module 20444 of the finger vein authentication application 2044 processes the captured infrared images of finger vein pattern of the finger 15 and determines whether the captured infrared images of finger vein pattern of the finger 15 exist in the finger vein image storage module 20442. When the captured infrared images of finger vein pattern of the finger 15 do not exist in the finger vein image storage module 20442, the captured infrared images of finger vein pattern of the finger 15 are stored into the finger vein image storage module 20442 along with the user's information.

At query block 606, the user decides whether to continue collecting infrared images of finger vein pattern of more people. If yes, the method 600 proceeds back to block 602 to collect additional infrared images of finger vein pattern of more people. Otherwise, the method 600 proceeds to block 608 to authenticate the user using the captured infrared images of finger vein pattern of the finger 15.

At block 608, the finger vein authentication module 20446 of the finger vein authentication application 2044 authenticate the user using the captured infrared image of finger vein patterns of the finger 15 and the set of infrared images of finger vein patterns stored in the finger vein image storage module 20442.

When the captured infrared image of finger vein patterns of the finger 15 match at least one of the set of infrared images of finger vein patterns stored in the finger vein image storage module 20442, the finger vein authentication module 20446 generates a positive authentication.

When the captured infrared image of finger vein patterns of the finger 15 do not match at least one of the set of infrared images of finger vein patterns stored in the finger vein image storage module 20442, the finger vein authentication module 20446 generates a negative authentication.

At block 610, the finger vein authentication module 20446 of the finger vein authentication application 2044 transmits the authentication results to one of the finger vein authentication application systems 30. In one embodiment, when the finger vein authentication system 100 is used in a banking user authentication system, and when the finger vein authentication module 20446 generates a positive authentication, the user gains access to the banking system. In another embodiment, when the finger vein authentication system 100 is used in an employee security authentication system, and when the finger vein authentication module 20446 generates a negative authentication, the user is denied the entry of a secured area. In yet another embodiment, when the finger vein authentication system 100 is used in an automotive driver authentication system, and when the finger vein authentication module 20446 generates a positive authentication, the user is permitted to drive the automobile. The finger vein authentication application systems 30 may also include a credit card authentication system, a firearm user authentication system, a computer and network authentications system, an end point security system, an intelligent lock, an intelligent lock for safe and gun lockers, and an automated teller machine authentication system.

At query block 612, the user decides whether to continue to perform finger vein authentication. If yes, the method 600 proceeds back to block 602 to collect additional infrared images of finger vein pattern of more people. Otherwise, the method 600 ends.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A finger vein imaging device comprising:
one or more finger vein image sensors for capturing at least one infrared image of finger vein pattern of a target human's finger; and
one or more infrared light sources positioned at an opposite side of the one or more finger vein image sensors,
wherein the finger is positioned between the one or more infrared light sources and the one or more finger vein image sensors, the infrared light from the one or more infrared light sources irradiates the finger to generate the infrared image of finger vein pattern of the finger on the one or more finger vein image sensors, and the one or more finger vein image sensors captures the infrared image of finger vein pattern of the finger.

2. The finger vein imaging device of claim 1, wherein each of the one or more infrared light sources comprises an infrared light-emitting diode (LED), a near-infrared LED, an infrared light bulb, a near-infrared light bulb and any other infrared and near-infrared light sources, wherein the one or more infrared light sources are arranged in one or more rows and one or more columns on an infrared light source panel.

3. The finger vein imaging device of claim 1, wherein each of the one or more finger vein image sensors comprises:
a finger vein image sensor;
a lens positioned between the finger and the finger vein image sensor; and
an infrared filter positioned between the lens and the finger vein image sensor for improving quality of the infrared image of finger vein pattern of the finger.

4. The finger vein imaging device of claim 3, further comprising a rectangular-shaped finger vein sensor enclosure having a lower compartment for positioning the one or more infrared light sources and an upper compartment for positioning the one or more finger vein image sensors, wherein a top surface of the lower compartment comprises a transparent finger resting surface to rest the finger, and an in-position touch sensor, wherein when the finger is placed on the transparent finger resting surface and touches the in-position touch sensor, the finger vein imaging device is triggered to turn on the one or more infrared light sources and to capture at least one infrared image of finger vein pattern of the finger.

5. The finger vein imaging device of claim 3, further comprising a cylindrical finger vein sensor enclosure having a hollow inside, open in a first end, and closed in a second end for positioning the one or more infrared light sources and the one or more finger vein image sensors, wherein the closed second end further comprises a transparent finger resting surface to rest the finger, and an in-position touch sensor, wherein when the finger is placed on the transparent finger resting surface and touches the in-position touch sensor, the finger vein imaging device is triggered to turn on the one or more infrared light sources and to capture at least one infrared image of finger vein pattern of the finger.

6. The finger vein imaging device of claim 5, wherein the cylindrical finger vein sensor enclosure further comprises one or more optical reflectors, wherein the one or more optical reflectors comprise a reflecting mirror, a triangular reflecting glass, and any other optical reflecting devices.

7. A finger vein authentication system comprising:
at least one finger vein imaging device, wherein the finger vein imaging device comprises one or more finger vein image sensors for capturing at least one infrared image of finger vein pattern of a target human's finger resting on a transparent finger resting surface, an in-position touch sensor, and one or more infrared light sources positioned at an opposite side of the one or more finger vein image sensors, when the finger is placed on the transparent finger resting surface and touches the in-position touch sensor, the finger vein imaging device is triggered to turn on the one or more infrared light sources and to capture one or more infrared image of finger vein patterns of the finger; and
a finger vein authentication controller, wherein the finger vein authentication controller comprises a processor and a non-volatile memory storing an operating system and a finger vein authentication application, wherein the finger vein authentication application includes: a finger vein image storage module, a finger vein image processing module, and a finger vein authentication module, when executed by the processor, the finger vein authentication application causes the processor to perform one or more of:
receiving, by the finger vein image storage module, captured one or more infrared image of finger vein patterns of the finger, when the finger vein imaging device captures the one or more infrared image of finger vein patterns of the finger;
comparing, by the finger vein image processing module, the captured one or more infrared image of finger vein patterns of the finger with a plurality of infrared images of finger vein patterns stored in the finger vein image storage module;
generating, by the finger vein authentication module, a positive authentication when the captured one or more infrared image of finger vein patterns of the finger match at least one of the plurality of infrared images of finger vein patterns stored in the finger vein image storage module; and
generating, by the finger vein authentication module, a negative authentication when the captured one or more infrared image of finger vein patterns of the finger do not match at least one of the plurality of infrared images of finger vein patterns stored in the finger vein image storage module.

8. The finger vein authentication system of claim 7, further comprises a finger vein image database for providing the plurality of infrared images of finger vein patterns to be stored in the finger vein image storage module of the finger vein authentication application.

9. The finger vein authentication system of claim 7, further comprises a plurality of finger vein authentication application systems, wherein the plurality of finger vein authentication application systems comprises:
a banking user authentication system;
a credit card authentication system;
an automotive driver authentication system;
a firearm user authentication system;
an employee security authentication system;
a computer and network authentications system;
an end point security system;
an intelligent lock;
an intelligent lock for safe and gun lockers; and
an automated teller machine authentication system.

10. The finger vein authentication system of claim 7, wherein each of the one or more infrared light sources comprises an infrared light-emitting diode (LED), a near-infrared LED, an infrared light bulb, a near-infrared light bulb and any other infrared and near-infrared light sources, wherein the one or more infrared light sources are arranged in one or more rows and one or more columns on an infrared light source panel.

11. The finger vein authentication system of claim 10, wherein each of the one or more finger vein image sensors comprises:
a finger vein image sensor;
a lens positioned between the finger and the finger vein image sensor; and
an infrared filter positioned between the lens and the finger vein image sensor for improving quality of the infrared image of finger vein pattern of the finger.

12. The finger vein authentication system of claim 11, further comprising a rectangular-shaped finger vein sensor enclosure having a lower compartment for positioning the one or more infrared light sources and an upper compartment for positioning the one or more finger vein image sensors, wherein a top surface of the lower compartment comprises a transparent finger resting surface to rest the finger, and an in-position touch sensor, wherein when the finger is placed on the transparent finger resting surface and touches the in-position touch sensor, the finger vein imaging device is triggered to turn on the one or more infrared light sources and to capture at least one infrared image of finger vein pattern of the finger.

13. The finger vein authentication system of claim 11, further comprising a cylindrical finger vein sensor enclosure having a hollow inside, open in a first end, and closed in a second end for positioning the one or more infrared light sources and the one or more finger vein image sensors, wherein the closed second end further comprises a transparent finger resting surface to rest the finger, and an in-position touch sensor, wherein when the finger is placed on the transparent finger resting surface and touches the in-position touch sensor, the finger vein imaging device is triggered to turn on the one or more infrared light sources and to capture at least one infrared image of finger vein pattern of the finger.

14. The finger vein authentication system of claim 13, wherein the cylindrical finger vein sensor enclosure further comprises one or more optical reflectors, wherein the one or more optical reflectors comprise a reflecting mirror, a triangular reflecting glass, and any other optical reflecting devices.

15. A method of using a finger vein authentication system, comprising:
retrieving, by a finger vein image storage module of a finger vein authentication application of the finger vein authentication system, a plurality of infrared images of finger vein patterns from a finger vein image database and storing the retrieved infrared images of finger vein patterns in the finger vein image storage module.
connecting one or more finger vein imaging devices 10 to a finger vein authentication controller to capture one or more infrared images of finger vein pattern of a target human's finger;
receiving captured one or more infrared image of finger vein patterns of the finger, by the finger vein image storage module of the finger vein authentication application, when the finger vein imaging device captures the one or more infrared image of finger vein patterns of the finger;
comparing, by a finger vein image processing module of the finger vein authentication application, the captured one or more infrared image of finger vein patterns of the finger with the plurality of infrared images of finger vein patterns stored in the finger vein image storage module;
generating, by a finger vein authentication module of the finger vein authentication application, a positive authentication when the captured one or more infrared image of finger vein patterns of the finger match at least one of the plurality of infrared images of finger vein patterns stored in the finger vein image storage module; and
generating, by the finger vein authentication module of the finger vein authentication application, a negative authentication when the captured one or more infrared image of finger vein patterns of the finger do not match at least one of the plurality of infrared images of finger vein patterns stored in the finger vein image storage module.

16. The method of claim 15, wherein the finger vein authentication system comprises:
at least one finger vein imaging device, wherein the finger vein imaging device comprises one or more finger vein image sensors for capturing at least one infrared image of finger vein pattern of a target human's finger resting on a transparent finger resting surface, an in-position touch sensor, and one or more infrared light sources positioned at an opposite side of the one or more finger vein image sensors, when the finger is placed on the transparent finger resting surface and touches the in-position touch sensor, the finger vein imaging device is triggered to turn on the one or more infrared light sources and to capture one or more infrared image of finger vein patterns of the finger; and
the finger vein authentication controller having a processor and a non-volatile memory storing an operating system and the finger vein authentication application having: the finger vein image storage module, the finger vein image processing module, and the finger vein authentication module.

17. The method of claim 16, wherein each of the one or more infrared light sources comprises an infrared light-emitting diode (LED), a near-infrared LED, an infrared light bulb, a near-infrared light bulb and any other infrared and near-infrared light sources, wherein the one or more infrared light sources are arranged in one or more rows and one or more columns on an infrared light source panel, and each of the one or more finger vein image sensors comprises: a finger vein image sensor; a lens positioned between the finger and the finger vein image sensor; and an infrared filter positioned between the lens and the finger vein image sensor for improving quality of the infrared image of finger vein pattern of the finger.

18. The method of claim 17, further comprising a rectangular-shaped finger vein sensor enclosure having a lower compartment for positioning the one or more infrared light sources and an upper compartment for positioning the one or more finger vein image sensors, wherein a top surface of the lower compartment comprises a transparent finger resting surface to rest the finger, and an in-position touch sensor, wherein when the finger is placed on the transparent finger resting surface and touches the in-position touch sensor, the finger vein imaging device is triggered to turn on the one or more infrared light sources and to capture at least one infrared image of finger vein pattern of the finger.

19. The method of claim 17, further comprising a cylindrical finger vein sensor enclosure having a hollow inside, open in a first end, and closed in a second end for positioning the one or more infrared light sources and the one or more finger vein image sensors, wherein the closed second end further comprises a transparent finger resting surface to rest the finger, and an in-position touch sensor, wherein when the finger is placed on the transparent finger resting surface and touches the in-position touch sensor, the finger vein imaging device is triggered to turn on the one or more infrared light sources and to capture at least one infrared image of finger vein pattern of the finger.

20. The method of claim 15, wherein the finger vein authentication system comprises a plurality of finger vein authentication application systems, wherein the plurality of finger vein authentication application systems comprises:
a banking user authentication system;
a credit card authentication system;
an automotive driver authentication system;
a firearm user authentication system;
an employee security authentication system;
a computer and network authentications system;
an end point security system;
an intelligent lock;
an intelligent lock for safe and gun lockers; and
an automated teller machine authentication system.
